(19) United States
(12) Patent Application Publication
(10) Pub. No.: US 2004/0223314 A1
(43) Pub. Date: Nov. 11, 2004

(54) Flat lighting structure

(75) Inventors: Lin Ching-Huang, Magung City (TW); Mai Che-Kuei, Hsinchu (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: Toppoly Optoelectronics Corp., Chu-Nan Township (TW)

(21) Appl. No.: 10/750,137

(22) Filed: Dec. 31, 2003

(30) Foreign Application Priority Data
Jan. 2, 2003 (TW) 92100065

(51) Int. Cl. F21V 7/04

(52) U.S. Cl. 362/31

(57) ABSTRACT

The purpose of the present invention is to provide a flat lighting structure for a light source of a liquid crystal display (LCD). The flat lighting structure includes a light guide plate having a side, a light guide stick having two ends and disposed by the side of the light guide plate, and a first luminary and a second luminary disposed at the two ends of the light guide stick for providing a light, wherein the light guide stick further comprises a light guide concave disposed between the first luminary and the second luminary for guiding the light toward the light guide plate.

### FIELD OF THE INVENTION

The present invention is related to a flat lighting structure and more particularly, to a flat lighting structure for a light source of a liquid crystal display (LCD).

### BACKGROUND OF THE INVENTION

A lighting structure is a kind of optical instruments, which are usually applied in a digital camera, a personal digital assistant (PDA), a satellite guidance system, a medical article, a notebook computer (NB), and a LCD monitor. Because the board of the TFT-LCD is not luminiferous, there should be a light source module added thereon. The lighting structure is an important optical instrument in the light source module and taken to a key part of the TFT-LCD.

With regard to the internal structure of the lighting structure, the lighting structure is consisting of a luminary, a reflecting plate, a light guide plate. The light guide plate is a smooth-surface plate made of propylene by means of jetting to mold and pressing. The bottom of the light guide plate further includes plural diffusing spots, which are made of high-reflecting and light-unabsorbable materials by means of halftone printing. The luminary, Cathode Ray Tube, is disposed near the thicker side of the light guide plate and provides a light reflected into the thinner side of the light guide plate. When the reflected light arrives at the diffusing spots, it will be scattered and diffused at several angles and then be emitted normally from the top face of the light guide plate. Meanwhile the diffusing spots having different densities and different sizes will uniform the light emitted from the top face of the light guide plate. On the other hand, the reflecting plate disposed under the light guide plate will back reflect the light emitted from the bottom of the light guide plate thereby the utility rate of the light increasing.

In actual application of the lighting structures, the deposition of the luminary always introduces some problems and the light can't be guided uniformly from the light guide plate. Please refer to FIG. 1(a). It illustrates a three-dimensional picture of a flat lighting structure according to the prior art. The flat lighting structure includes a light guide plate 11 having a thicker side 111 and a thinner side 112, and plural luminaries 12, light emitting diodes (LED), disposed on the thicker side of the light guide plate 11 for providing the light guide plate with a light. The bottom of the light guide plate 11 further includes plural diffusing spots (not shown), which are made by means of halftone printing. The plural LEDs 12 disposed by the thicker side 111 of the light guide plate 11 provides a light reflected into the thinner side 112 of the light guide plate 11. When the reflected light arrives at the diffusing spots, it will be scattered and diffused at several angles and then be emitted normally from the top face of the light guide plate 11. Meanwhile the diffusing spots having different densities and different sizes will uniform the light emitted from the top face of the light guide plate 11. However, the plural LEDs disposed by the thicker side 111 of the light guide plate 11 can't provide an uniform light source, shown in FIG. 1(b). The light has lost uniform before arriving the diffusing spots. The diffusing spots having different densities and different sizes won't be able to adjust and uniform the light emitted from the top face of the light guide plate 11.

Please refer to FIG. 2. It illustrate another flat lighting structure according to the prior art. The flat lighting structure includes a light guide plate 21 having a thicker side 211 and a thinner side 212, a light guide stick 23 disposed at the thicker side 211 of the light guide plate, and two light emitting diodes (LEDs) 22 respectively disposed at two ends of light guide stick 23 for providing the flat lighting structure with a light. Being shown in FIG. 2, the light emitted from the LEDs 22 and refracted via the light guide stick 23 won't be uniform. Similar to the above instance, an uniform light source can't be provided. Thus, the diffusing spots having different densities and different sizes won't be able to adjust and uniform the light emitted from the top face of the light guide plate 11. Accordingly, there should be a flat lighting structure provided for solving the above problems and providing an uniform light source.

Therefore, it is tried to rectify those drawbacks and provide a flat lighting structure by the present applicant. This invention is a flat lighting structure for solving the above problems and providing an uniform light source.

### SUMMARY OF THE INVENTION

It is therefore a primary objective of the present invention to provide a flat lighting structure for a light source of a LCD, which can provide a uniform light.

According to the present invention, the flat lighting structure includes a light guide plate having a side, a light guide stick having two ends and disposed by the side of the light guide plate, and a first luminary and a second luminary disposed at the two ends of the light guide stick for providing a light, wherein the light guide stick further comprises a light guide concave disposed between the first luminary and the second luminary for guiding the light toward the light guide plate.

Certainly, the side can be a thicker side of the light guide plate.

Preferably, the light guide plate farther includes a bottom incline having plural diffusing spots for guiding the light to emit normally from the light guide plate.

Certainly, the diffusing spots can be ones selected from a group consisting of a dot matrix structure, a V-cut notch structure and a mixture thereof.

Certainly, the first luminary and the second luminary can be light emitting diodes.

Certainly, the light guide concave can be one selected from a group consisting of an incline, a curved surface and a mixture thereof.

Preferably, the light guide concave further includes a reflecting layer for reflecting the light.

Certainly, the first luminary and the second luminary can be of the same type.

Certainly, the light guide concave can be symmetrical with respect to the first luminary and the second luminary for guiding the light in a specific path.

Certainly, the first luminary and the second luminary can be of different types.

Certainly, the light guide concave can be asymmetric with respect to the first luminary and the second luminary for guiding the light in a specific path.

Certainly, the light guide stick further includes a reflecting layer for reflecting the light.

According to another preferred embodiment of the present invention, the flat lighting structure includes a light guide plate having a side, and a first luminary and a second luminary disposed at two ends of the side of the light guide plate for providing a light, wherein the light guide plate further comprises a light guide concave disposed between the first luminary and the second luminary for guiding the light toward the light guide plate.

Certainly, the side can be a thicker side of the light guide plate.

Preferably, the light guide plate further includes a bottom incline having plural diffusing spots for guiding the light to emit normally from the light guide plate.

Certainly, the diffusing spots can be ones selected from a group consisting of a dot matrix structure, a V-cut notch structure and a mixture thereof.

Certainly, the first luminary and the second luminary can be light emitting diodes.

Certainly, the light guide concave can be one selected from a group consisting of an incline, a curved surface and a mixture thereof.

Preferably, the light guide concave further includes a reflecting layer for reflecting the light.

Preferably, the light guide plate further includes a refracting layer for changing a transmitting direction of the light.

Preferably, the refracting layer further includes a cavity on the light guide plate.

Certainly, the cavity can be filled with a refractable material.

Certainly, the first luminary and the second luminary can be of the same type.

Certainly, the light guide concave can be symmetrical with respect to the first luminary and the second luminary for guiding the light in a specific path.

Certainly, the first luminary and the second luminary can be of different types.

Certainly, the light guide concave can be asymmetric with respect to the first luminary and the second luminary for guiding the light in a specific path.

The foregoing and other features and advantages of the present invention will be more clearly understood through the following descriptions with reference to the drawings, wherein:

### BRIEF DESCRIPTION OF THE DRAWING

FIGS. 1(a)-(b) illustrate a flat lighting structure according to the prior art;

FIG. 2 illustrates another flat lighting structure according to the prior art;

FIG. 3(a) illustrates a three-dimensional picture of a flat lighting structure according to the present invention;

FIGS. 3(b)-(d) illustrate several vertical views of flat lighting structures according to the present invention;

FIG. 4 illustrates a flat lighting structure having a refracting layer according to the present invention;

FIG. 5 illustrates a flat lighting structure having a reflecting layer according to the present invention;

FIGS. 6(a)-(b) illustrate another preferred embodiment of a flat lighting structure according to the present invention; and

FIG. 7 illustrates another preferred embodiment of a flat lighting structure having a reflecting layer according to the present invention,

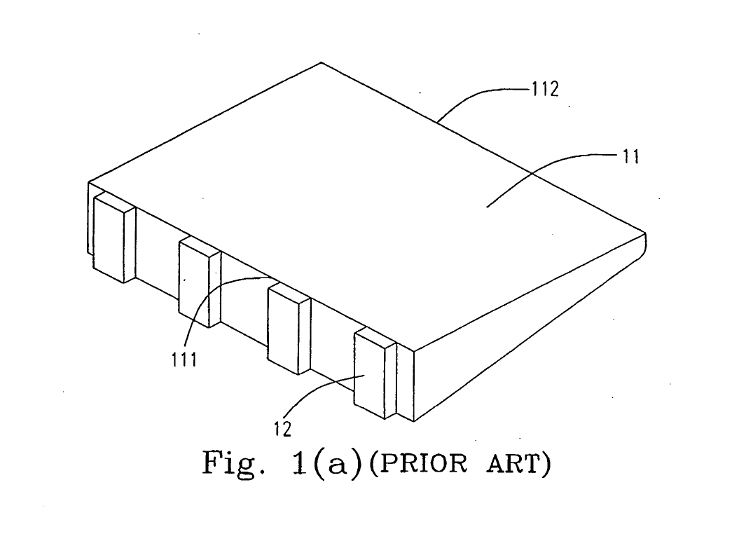

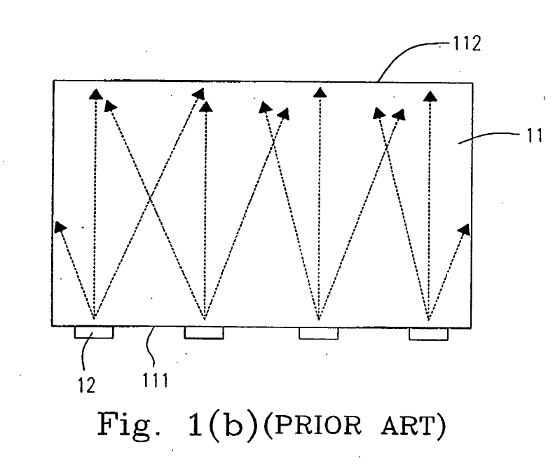

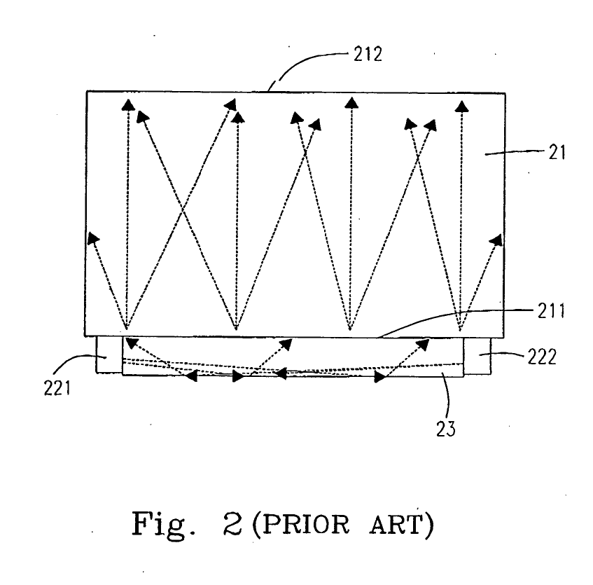

### DETAILED DESCRIPTION OF THE PREFERRED EMBODIMENTS

The primary objective of the present invention is to provide a flat lighting structure having luminaries disposed by a side thereof and an incline guiding the light at determined paths thereby the brightness of the lighting structure increasing and the effect of the uneven emitting caused by luminaries being decreasing.

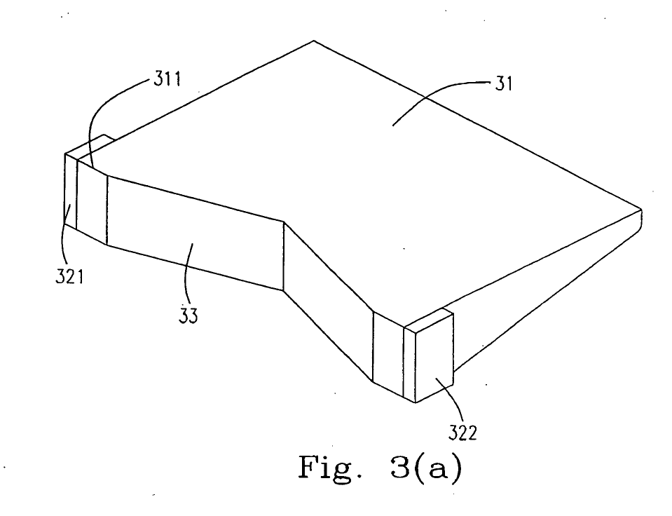

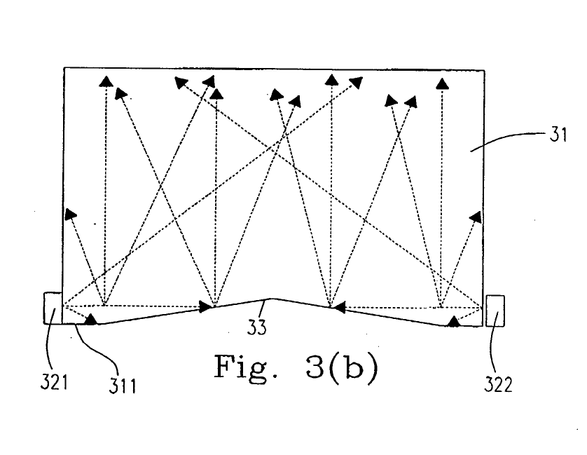

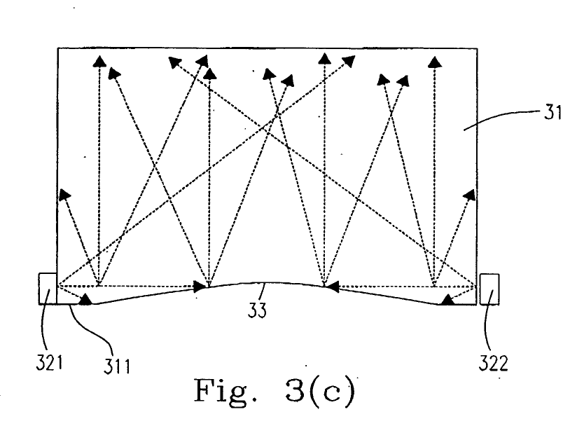

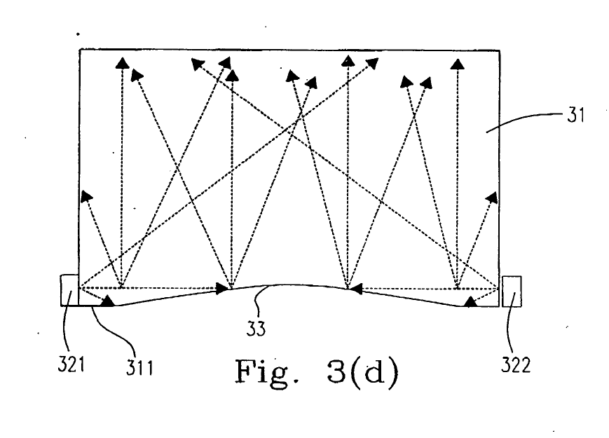

Please refer to FIG. 3. It illustrates the first preferred embodiment of a flat lighting structure according to the present invention. Being shown in FIG. 3(a), the flat lighting structure includes a light guide plate 31 having a side 311, and a first luminary 321 and a second luminary 322 disposed at two ends of the side 311 of the light guide plate 31 for providing a light, wherein the light guide plate 31 further comprises a light guide concave 33 disposed between the first luminary 321 and the second luminary 322 for guiding the light toward the light guide plate 31. Meanwhile, the side 311 is a thicker side of the light guide plate 31. The light guide plate 31 further includes a bottom incline having plural diffusing spots (not shown) for guiding the light to emit normally from the light guide plate 31. The diffusing spots can be ones selected from a group consisting of a dot matrix structure, a V-cut notch structure and a mixture thereof. In this embodiment, the first luminary 321 and the second luminary 322 are light emitting diodes and the light guide concave 33 is one selected from a group consisting of an incline (shown in FIG. 3(b)), a curved surface (shown in FIG. 3(c)) and a mixture thereof (shown in FIG. 3(d)). When the first luminary 321 and the second luminary 322 are of the same type, the light guide concave 33 should be symmetrical with respect to the first luminary 321 and the second luminary 322 for guiding the light in a specific path. On the contrary, when the first luminary 321 and the second luminary 322 are of different types, of different number or disposed in different positions, the light guide concave 33 should be asymmetric with respect to the first luminary 321 and the second luminary 322 for guiding the light in a specific path.

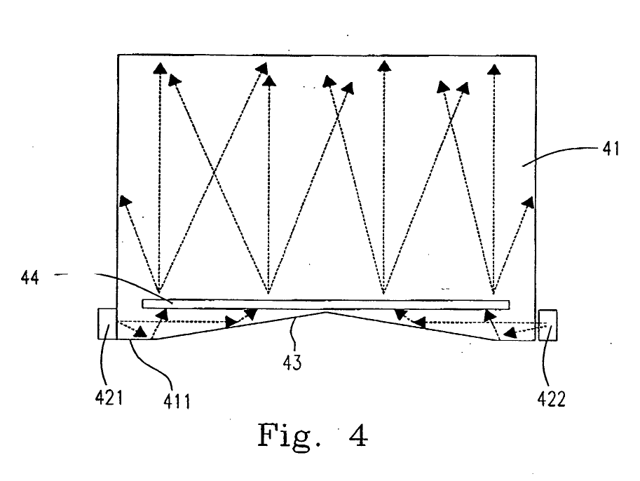

Please refer to FIG. 4. It illustrates another preferred embodiment according to the present invention. The flat lighting structure not only includes a light guide plate 41 having a thicker side 411, a first luminary 421 and a second luminary 422, and a light guide concave 43, but also includes a refracting layer 44 disposed in the light guide plate 41 for changing a transmitting direction of the light. The refracting layer 44 further includes a cavity on the light guide plate 41 and the cavity could be filled with an air, the same refractable material or the different retractable materials as the medium, thereby the brightness of the flat lighting structure increasing.

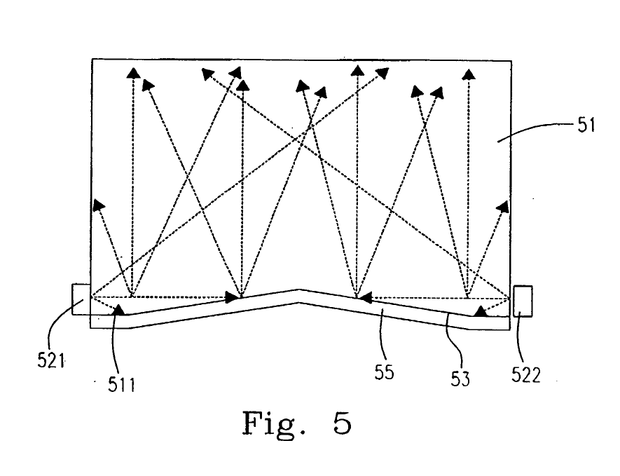

Please refer to FIG. 5. It illustrates third preferred embodiment of a flat lighting structure according to the present invention. Compared with the above embodiment, this embodiment of the flat lighting structure further includes a reflecting layer 55 disposed by the light guide concave 53 for reflecting the light. In other words, this embodiment of the flat lighting structure includes a light guide concave 53 and a reflecting layer 55. Thus, the incident light provided by the first luminary 521 and the second luminary 522 will be used well and won't be passed through the light guide concave 53 to interfere with each other.

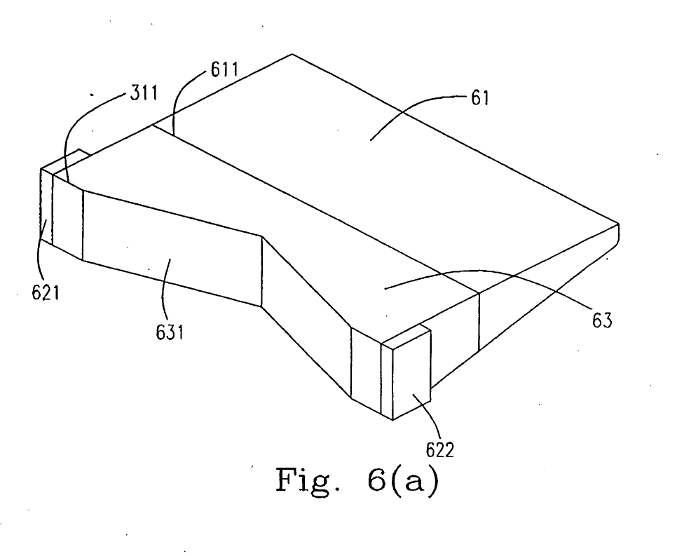

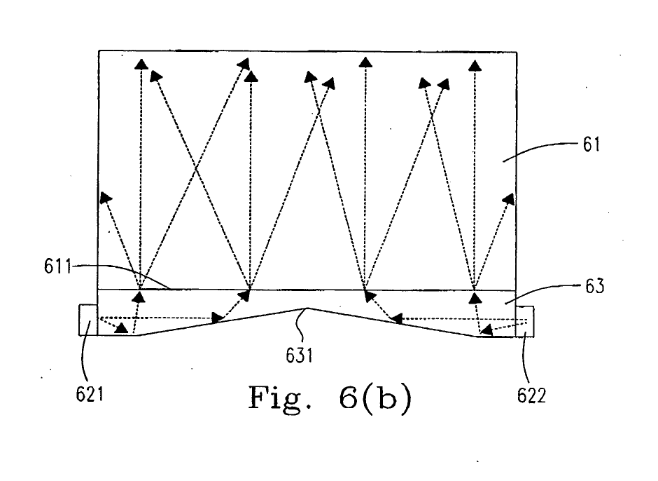

Please refer to FIG. 6. It illustrates other preferred embodiment of a flat lighting structure according to the present invention. The flat lighting structure includes a light guide plate 61 having a side 611, a light guide stick 63 having two ends and disposed by the side 611 of the light guide plate 61, and a first luminary 621 and a second luminary 622 disposed at the two ends of the light guide stick 63 for providing a light, wherein the light guide stick 63 further comprises a light guide concave 631 disposed between the first luminary 621 and the second luminary 622 for guiding the light toward the light guide plate 61. Meanwhile, the side 611 is a thicker side of the light guide plate 61. Similar to the above embodiment, the light guide plate 61 further includes a bottom incline having plural diffusing spots (not shown) for guiding the light to emit normally from the light guide plate 61. Certainly, the diffusing spots could be ones selected from a group consisting of a dot matrix structure, a V-cut notch structure and a mixture thereof. In this embodiment, the first luminary 621 and the second luminary 622 are light emitting diodes, and the light guide concave 631 is one selected from a group consisting of an incline, a curved surface and a mixture thereof. When the first luminary 621 and the second luminary 622 are of the same type, the light guide concave 631 should be symmetrical with respect to the first luminary 621 and the second luminary 622 for guiding the light in a specific path. On the contrary, when the first luminary 621 and the second luminary 622 are of different types, of different number or disposed in different positions, the light guide concave 631 should be asymmetric with respect to the first luminary 621 and the second luminary 622 for guiding the light in a specific path.

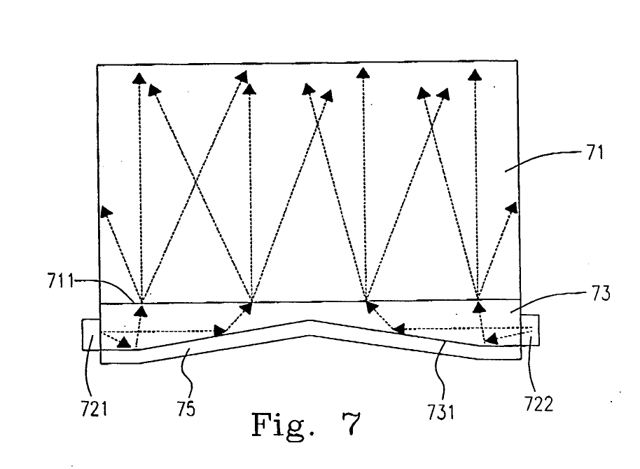

Being shown in FIG. 7, the flat lighting structure of the preferred embodiment according to the present invention further includes a reflecting layer 75 disposed by the light guide concave 731. Thereby, the incident light provided by the first luminary 721 and the second luminary 722 will be used well and won't be passed through the light guide concave 731 to interfere with each other.

Accordingly, the invention is a flat lighting structure for a light source module in LCD. It involves a light guide concave for uniformly guiding the light toward the light guide plate. Furthermore, a reflecting layer or a refracting layer are introduced to increase the effect of the light guide concave. Therefore, the flat lighting structure of the present invention will omit the uneven emitting effect of luminaries and increase the brightness of the flat lighting structure. Moreover, the flat lighting structure could be applied in a back-light module or a front-light module. On other words, it could be applied in a reflecting-type or a through-type LCD. It is believed that the present invention is practicable for the industry.

While the invention has been described in terms of what are presently considered to be the most practical and preferred embodiments, it is to be understood that the invention need not to be limited to the disclosed embodiment. On the contrary, it is intended to cover various modifications and similar arrangements included within the spirit and scope of the appended claims, which are to be accorded with the broadest interpretation so as to encompass all such modifications and similar structures.

What is claimed is:

1. A flat lighting structure comprising:
a light guide plate having a side;
a light guide stick having two ends and disposed by said side of said light guide plate; and
a first luminary and a second luminary disposed at said two ends of said light guide stick for providing a light, wherein said light guide stick further comprises a light guide concave disposed between said first luminary and said second luminary for guiding said light toward said light guide plate.

2. The flat lighting structure according to claim 1, wherein said side is a thicker side of said light guide plate.

3. The flat lighting structure according to claim 1, wherein said light guide plate further comprises a bottom incline having plural diffusing spots for guiding said light to emit normally from said light guide plate, wherein said diffusing spots are ones selected from a group consisting of a dot matrix structure, a V-cut notch structure and a mixture thereof.

4. The flat lighting structure according to claim 1, wherein said first luminary and said second luminary are light emitting diodes.

5. The flat lighting structure according to claim 1, wherein said light guide concave is one selected from a group consisting of an incline, a curved surface and a mixture thereof.

6. The flat lighting structure according to claim 1, wherein said light guide concave further comprises a reflecting layer for reflecting said light.

7. The flat lighting structure according to claim 1, wherein said light guide concave is symmetrical with respect to said first luminary and said second luminary for guiding said light in a specific path, wherein said first luminary and said second luminary are of the same type.

8. The flat lighting structure according to claim 1, wherein said first luminary and said second luminary are of different types.

9. The flat lighting structure according to claim 1, wherein said light guide concave is asymmetric with respect to said first luminary and said second luminary for guiding said light in a specific path.

10. The flat lighting structure according to claim 1, wherein said light guide stick further comprising a reflecting layer for reflecting said light.

11. A flat lighting structure comprising:
a light guide plate having a side; and
a first luminary and a second luminary disposed at two ends of said side of said light guide plate for providing a light, wherein said light guide plate further comprises a light guide concave disposed between said first luminary and said second luminary for guiding said light toward said light guide plate.

12. The flat lighting structure according to claim 11, wherein said side is a thicker side of said light guide plate.

13. The flat lighting structure according to claim 11, wherein said light guide plate further comprises a bottom incline having plural diffusing spots for guiding said light to emit normally from said light guide plate, wherein said diffusing spots are ones selected from a group consisting of a dot matrix structure, a V-cut notch structure and a mixture thereof.

14. The flat lighting structure according to claim 11, wherein said first luminary and said second luminary are light emitting diodes.

15. The flat lighting structure according to claim 11, wherein said light guide concave is one selected from a group consisting of an incline, a curved surface and a mixture thereof.

16. The flat lighting structure according to claim 11, wherein said light guide concave further comprises a reflecting layer for reflecting said light.

17. The flat lighting structure according to claim 11, wherein said light guide plate further comprising a refracting layer for changing a transmitting direction of said light.

18. The flat lighting structure according to claim 17, wherein said refracting layer includes a cavity on said light guide plate.

19. The flat lighting structure according to claim 18, wherein said cavity is filled with a refractable material.

20. The flat lighting structure according to claim 11, wherein said light guide concave is symmetrical with respect to said first luminary and said second luminary for guiding said light in a specific path, wherein said first luminary and said second luminary are of the same type.

21. The flat lighting structure according to claim 11, wherein said first luminary and said second luminary are of different types.

22. The flat lighting structure according to claim 21, wherein said light guide concave is asymmetric with respect to said first luminary and said second luminary for guiding said light in a specific path.
